(19) United States
(12) Patent Application Publication
(10) Pub. No.: US 2004/0032136 A1
(43) Pub. Date: Feb. 19, 2004

(54) Narrow-trenching tool system

(76) Inventor: Bryan Smith, Tipton, OK (US)

Correspondence Address: STONEMAN LAW OFFICES, LTD, 3113 NORTH 3RD STREET, PHOENIX, AZ, 85012, US

(21) Appl. No.: 10/616,127

(22) Filed: Jul. 8, 2003

Related U.S. Application Data
(60) Provisional application No. 60/394,704, filed on Jul. 8, 2002.

(51) Int. Cl. A01B 1/02

(52) U.S. Cl. 294/49; 294/60; 294/57

(57) ABSTRACT

A slim-line hand tool trenching system for narrowly penetrating topsoil and creating a trench with a wider bottom and a smaller top opening, with improved vertical handling and providing reduced topsoil damage.

### CROSS-REFERENCE TO RELATED APPLICATION

The present application is related to prior provisional application Serial No. 60/394,704, filed Jul. 8, 2002, entitled “CABLE TRENCHING SYSTEM”, the contents of which are incorporated herein by this reference and are not admitted to be prior art with respect to the present invention by the mention in this cross-reference section.

### BACKGROUND

This invention relates to providing a system for narrow trenching with a hand-operated trencher tool. Typically, in many parts of the earth, where the soil conditions allow, hand tools are used to create trenches in the topsoil of about six inches to about eighteen inches in depth for the purpose of burying small to medium-sized cable, wire or piping. Such earth-splitting tools are preferred in locals where power trenchers are undesirable or where a relatively minor trench in the surface of the topsoil is preferred, such as a golf course or landscaped area. In such areas, it is preferable to cut through the soil with as little ancillary destruction of the topsoil as necessary. Shovels and spades of many designs have been used for this purpose, however, many of the prior art utensils are either inefficient or create a larger fissure than the present invention.

Furthermore, earth-splitting tools require a varying degree of downward force depending on the hardness of the soil. Different tools have varying degrees of vertical handling and cutting ability. A tool that increases the ease with which the cutting and vertical handling may be applied, and reduces the impact to the topsoil, would be of benefit and improved use.

### OBJECTS OF THE INVENTION

A primary object and feature of the present invention is to provide a system tool for hand-operated trenching that cuts through topsoil easier and with minor ancillary topsoil damage. It is a further object and feature of the present invention to provide such a system that provides improved vertical handling for the operator of the trencher tool. It is a further object and feature of the present invention to provide such a system that allows a user to hold the handle of the tool away from the user's body in order to improve the comfort and vertical handling of the user, especially for a user with a larger belly. A further primary object and feature of the present invention is to provide such a system tool that is efficient, inexpensive, and handy. Other objects and features of this invention will become apparent with reference to the following descriptions.

### SUMMARY OF THE INVENTION

In accordance with a preferred embodiment hereof, this invention provides a narrow-trenching tool system for transferring the force of a user to narrowly penetrate topsoil, create a trench with a wider bottom, and create a smaller top opening below the topsoil, comprising, in combination: single blade means for cutting through the topsoil, having at least one blade top portion and at least one substantially horizontal bottom edge; foot pedestal portion means for permitting the user to apply weight on such single blade means, situate adjacent to such at least one blade top portion; and handle means for providing at least one handle, having at least one handle top portion and at least one handle bottom portion; wherein such handle means comprises attacher means for attaching such at least one handle bottom portion to such at least one handle top portion; wherein such handle top portion of such handle means comprises user-graspable element means; wherein such user-graspable element means is located at a horizontal distance from a vertical axis passing through such single blade means, structured and arranged to permit the user to apply maximum weight on such foot pedestal portion means while grasping such user-graspable element means; wherein applying downward force on such foot pedestal portion means, by the user, will normally assist such single blade means to cut through and penetrate the topsoil; and wherein applying a bi-directional horizontal force by the user to such user-graspable element means after penetration of the topsoil, while applying such downward force, will normally assist such single blade means to sweep an arc below the topsoil creating the trench with a wider bottom and a smaller top opening below the topsoil. Moreover, it provides such a narrow-trenching tool system wherein such user-graspable element means comprises at least one crossbar handle substantially perpendicular to such at least one handle top portion of such handle means. Additionally, it provides such a narrow-trenching tool system wherein such foot pedestal portion means comprises at least one substantially horizontal plate.

In accordance with another preferred embodiment hereof, this invention provides a narrow-trenching tool system for transferring the force of a user to narrowly penetrate topsoil, create a trench with a wider bottom, and create a smaller top opening below the topsoil, comprising, in combination: a single blade, having at least one blade top portion and at least one substantially horizontal bottom edge, structured and arranged to cut through the topsoil; at least one foot pedestal portion, situate adjacent to such at least one blade top portion, structured and arranged to permit the user to apply weight on such single blade; and at least one handle, having at least one handle top portion and at least one handle bottom portion; wherein such at least one handle comprises at least one attacher structured and arranged to attach such at least one handle bottom portion to such at least one handle top portion; wherein such at least one handle top portion of such at least one handle comprises at least one user-graspable element; wherein such at least one user-graspable element is located at a horizontal distance from a vertical axis passing through such single blade, structured and arranged to permit the user to apply maximum weight on such at least one foot pedestal while grasping such at least one user-graspable element; wherein applying downward force on such at least one foot pedestal portion by the user will normally assist such single blade to cut through and penetrate the topsoil; and wherein applying a bi-directional horizontal force by the user to such at least one user-graspable element after penetration of the topsoil while applying such downward force will normally assist such single blade to sweep an arc below the topsoil creating the trench with a wider bottom and a smaller top opening below the topsoil. Also, it provides such a narrow-trenching tool system wherein such at least one user-graspable element comprises at least one crossbar handle substantially perpendicular to such at least one handle top portion of such at least one handle. In addition, it provides such a narrow-trenching tool system wherein such at least one foot pedestal portion comprises at least one substantially horizontal plate. And, it provides such a narrow-trenching tool system wherein such single blade comprises a unitary metal blade.

Further, it provides such a narrow-trenching tool system wherein such unitary metal blade is tempered steel. Even further, it provides such a narrow-trenching tool system wherein such unitary metal blade is structured and arranged to penetrate the topsoil to a depth of between about six-inches and about twelve-inches. Moreover, it provides such a narrow-trenching tool system wherein such unitary metal blade is structured and arranged to penetrate the topsoil to a depth of about eight-inches. Additionally, it provides such a narrow-trenching tool system wherein such unitary metal blade is between about one-sixteenth-inch and about one-half inch thick. Also, it provides such a narrow-trenching tool system wherein such at least one handle comprises at least one rod. In addition, it provides such a narrow-trenching tool system wherein such at least one rod comprises at least one substantially hollow steel rod. And, it provides such a narrow-trenching tool system wherein such at least one substantially hollow steel rod comprises an outer diameter of between about three-quarters of an inch and one-and-one-half inches.

Even further, it provides such a narrow-trenching tool system wherein such at least one crossbar handle comprises at least one rod. Even further, it provides such a narrow-trenching tool system wherein such at least one rod comprises at least one substantially hollow steel rod. Moreover, it provides such a narrow-trenching tool system wherein such at least one crossbar handle is weldably attached substantially perpendicular to such at least one handle top portion of such at least one handle. Additionally, it provides such a narrow-trenching tool system wherein at least one handle comprises at least one bend. Also, it provides such a narrow-trenching tool system wherein: such at least one bend is located about twelve-inches to about sixteen-inches above the bottom of such at least one handle bottom portion; and such at least one bend is about two-degrees to about ten-degrees from vertical. In addition, it provides such a narrow-trenching tool system wherein such at least one bend is opposite and above a top portion of such at least one foot pedestal.

In accordance with another preferred embodiment hereof, this invention provides a narrow-trenching tool system for transferring the force of a user to narrowly penetrate topsoil, create a trench with a wider bottom, and create a smaller top opening below the topsoil, comprising, in combination: a single unitary tempered steel blade, having at least one blade top portion and at least one substantially horizontal bottom edge, structured and arranged to penetrate through the topsoil; at least one foot pedestal portion, situate adjacent to such at least one blade top portion, structured and arranged to permit the user to apply weight on such single blade; at least one handle, having at least one handle top portion and at least one handle bottom portion; and at least one crossbar handle substantially perpendicular to such at least one handle top portion of such at least one handle; wherein such at least one handle comprises at least one attacher structured and arranged to attach such at least one handle bottom portion to such at least one handle top portion; wherein such at least one handle top portion of such at least one handle comprises at least one user-graspable element; wherein such at least one crossbar handle is located at a horizontal distance from a vertical axis passing through such single blade, structured and arranged to permit the user to apply maximum weight on such at least one foot pedestal while grasping such at least one crossbar handle; wherein such at least one handle comprises at least one bend located about twelve-inches to about sixteen-inches above the bottom of such at least one handle bottom portion; wherein such at least one bend is about two-degrees to about ten-degrees from the vertical axis passing through such single blade; wherein applying downward force on such at least one foot pedestal portion by the user will normally assist such single blade to cut through and penetrate the topsoil; and wherein applying a bi-directional horizontal force by the user to such at least one user-graspable element after penetration of the topsoil while applying such downward force will normally assist such single blade to sweep an arc below the topsoil creating the trench with a wider bottom and a smaller top opening below the topsoil.

In accordance with another preferred embodiment hereof, this invention provides a narrow-trenching system method for narrowly penetrating topsoil, creating a trench with a wider bottom, and creating a smaller top opening below the topsoil, utilizing a narrow-trenching tool with single blade means for cutting through the topsoil, having at least one blade top portion and at least one substantially horizontal bottom edge; foot pedestal portion means for permitting the user to apply weight on such single blade means, situate adjacent to such at least one blade top portion; and handle means for providing a handle, having at least one handle top portion and at least one handle bottom portion; wherein such handle means comprises attacher means for attaching such at least one handle bottom portion to such at least one handle top portion; wherein such handle top portion of such handle means comprises user-graspable element means; wherein such user-graspable element means is located at a horizontal distance from a vertical axis passing through such single blade means, structured and arranged to permit the user to apply maximum weight on such foot pedestal portion means while grasping such user-graspable element means; wherein applying downward force on such foot pedestal portion means, by the user, will normally assist such single blade means to cut through and penetrate the topsoil; and wherein applying a bi-directional horizontal force by the user to such user-graspable element means after penetration of the topsoil, while applying such downward force, will normally assist such single blade means to sweep an arc below the topsoil creating the trench with a wider bottom and a smaller top opening below the topsoil, for placing of at least one trench element in such trench, comprising, in combination, the steps of: positioning the at least one substantially horizontal bottom edge of the single blade means perpendicular to the topsoil; applying pressure to the foot pedestal portion means; wherein the single blade means penetrates the topsoil; and applying a bi-directional horizontal force to the handle means.

And, it provides such a narrow-trenching system method further comprising the steps of: creating the trench with a wider bottom and a smaller top opening below the topsoil; removing the single blade means from the trench; placing the at least one trench element within the trench; and closing the smaller top opening in the topsoil.

### BRIEF DESCRIPTION OF THE DRAWINGS

FIG. 1 is a perspective view of the narrow-trenching system tool according to a preferred embodiment of the present invention.

FIG. 2 is a front view of the narrow-trenching system tool of FIG. 1.

FIG. 3 is a side view of the narrow-trenching system tool of FIG. 1.

FIG. 4 is a sectional view through section 4-4 of FIG. 2.

FIG. 5 is a sectional view through section 5-5 of FIG. 2.

FIG. 6 is a perspective view, partially in section, of a first step in the method of use, of the narrow-trenching system tool, according to a preferred embodiment of the present invention.

FIG. 7 is a perspective view, partially in section, of a second step in the method of use, of the narrow-trenching system tool, according to a preferred embodiment of the present invention.

FIG. 8 is a perspective view, partially in section, of a third step in the method of use, of the narrow-trenching system tool, according to a preferred embodiment of the present invention.

FIG. 9 is a perspective view, partially in section, of a fourth step in the method of use, of the narrow-trenching system tool, according to a preferred embodiment of the present invention.

### DETAILED DESCRIPTION OF A PREFERRED EMBODIMENT OF THE INVENTION

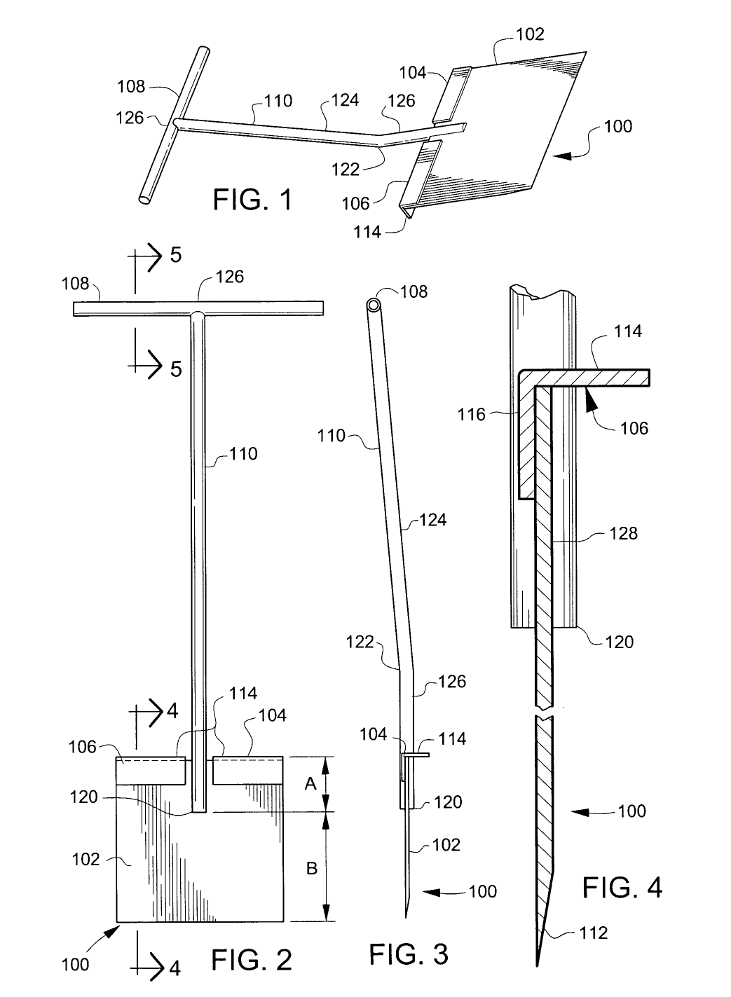

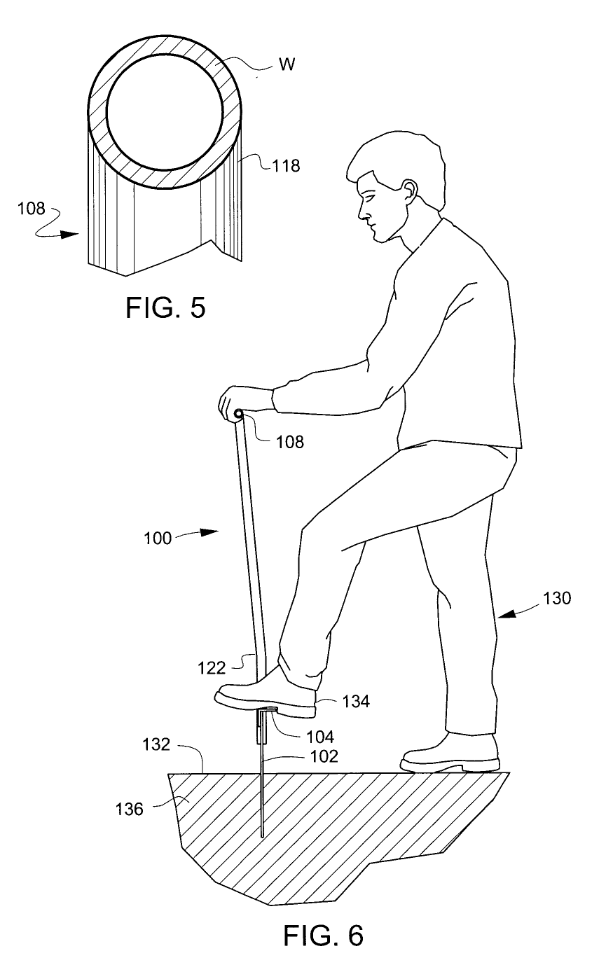

Reference is now made to the drawings. FIG. 1 is a perspective view of the narrow-trenching system tool 100 according to a preferred embodiment of the present invention. FIG. 2 is a front view of the narrow-trenching system tool 100 of FIG. 1. FIG. 3 is a side view of the narrow-trenching system tool 100 of FIG. 1. FIG. 4 is a sectional view through section 4-4 of FIG. 2.

The above referenced drawings will now be described. Preferably, the narrow-trenching system tool 100 comprises a blade 102, foot-plates 104 and 106, a horizontal handle 108 and a vertical handle 110 between the horizontal handle 108 and the blade 102, as shown. Preferably, the blade 102 is comprised of a single unitary piece of metal (embodying herein wherein such single blade comprises a unitary metal blade), preferably steel, preferably tempered steel (embodying herein wherein such unitary metal blade is tempered steel). Preferably, blade 102 is one foot square (twelve inches by twelve inches square), as shown. Preferably, the thickness of blade 102 is about one-quarter inch thick, tapering to a sharpened edge 112 (embodying herein wherein such unitary metal blade is between about one-sixteenth-inch and about one-half inch thick), as shown in FIG. 4, with a substantially horizontal bottom edge (embodying herein single blade means for cutting through the topsoil, having at least one blade top portion and at least one substantially horizontal bottom edge). Preferably, a narrow enough blade 102 is used to allow the minimum room needed to place the intended trench element into the trench. Upon reading the teachings of this specification, those skilled in the art will now appreciate that, under appropriate circumstances, considering such issues as cost, ease of manufacturing, mechanical properties of the configuration, the type of topsoil, etc., other blade configurations, such as composite metal, high-strength plastic, non-steel, non-square, non-horizontally edged bottoms, etc., may suffice.

Functionally, Applicant has discovered through experimentation that the preferred dimensions described above provide a blade 102 that has the following preferred characteristics: cuts through the surface layer with minimal displacement, cuts through the topsoil to a preferred depth of about eight inches (embodying herein wherein such unitary metal blade is structured and arranged to penetrate the topsoil to a depth of about eight-inches) with minimal weight bearing effort by the user while maximizing the longitudinal length of the cut and maintaining depth consistency throughout the longitudinal length. Upon reading the teachings of this specification, those skilled in the art will now appreciate that, under appropriate circumstances, considering issues such as, desired channel width, desired channel depth, etc., other dimensions, such as a longer blade, wider blade, non-horizontally edged bottoms, etc., may suffice. For example, the blade 102 preferably cuts the topsoil to a depth of between about six inches and about twelve inches. This arrangement embodies herein wherein such unitary metal blade is structured and arranged to penetrate the topsoil to a depth of between about six-inches and about twelve-inches.

Preferably, the narrow-trenching system tool 100 further comprises foot-plates 104 and 106, as shown. Preferably, foot-plates 104 and 106 are L-shaped metal, preferably steel, preferably one-quarter inch thick steel, preferably comprising a two inch top portion 114 and a one and one-half inch side portion 116, as shown (embodying herein foot pedestal portion means for permitting the user to apply weight on said single blade, situate adjacent to said at least one blade top portion; and embodying herein wherein said foot pedestal portion means comprises at least one substantially horizontal plate). Preferably, the foot-plates 104 and 106 are firmly attached to blade 102, most preferably by welding. Upon reading the teachings of this specification, those skilled in the art will now appreciate that, under appropriate circumstances, considering issues such as cost, ease of manufacturing, mechanical properties of the configuration, etc., other foot-plate configurations, such as rods, pipes, differing dimensions for portions 114 and 116, bolted attachment, non-welded attachment, etc., may suffice, provided they perform the necessary function of user weight transfer to the blade 102.

In addition to the above Figures, FIG. 5 provides a sectional view, through section 5-5, of FIG. 2. Preferably, handle 108 is a rod (embodying herein wherein such at least one crossbar handle comprises at least one rod), preferably a substantially hollow rod 118, preferably steel, preferably tempered steel, preferably a unitary rod (embodying herein handle means for providing a handle, having at least one handle top portion and at least one handle bottom portion). Most preferably, handle 108 comprises a one-inch outer diameter steel pipe having a wall thickness W of one-eighth of an inch, as shown in FIG. 5. Under appropriate circumstances, other materials or thickness may suffice. For example, handle 108 may be a solid rod or may have a thicker or thinner wall thickness; such as, for example, an outer diameter of between about three-quarters of an inch and one-and-one-half inches (embodying herein wherein such at least one substantially hollow steel rod comprises an outer diameter of between about three-quarters of an inch and one-and-one-half inches). Such variations, however, may adversely affect the economical benefits of the present invention as well as weight and handling characteristics taken into consideration by Applicant. Preferably, handle 108 is firmly attached to vertical handle 110, preferably by welding (embodying herein wherein such at least one crossbar handle is weldably attached substantially perpendicular to such at least one handle top portion of such at least one handle). Under appropriate circumstances, other attachment arrangements may suffice. Applicant prefers welding for good durability.

Preferably, handle 108 is firmly attached to vertical handle 110 such that the transverse center 126 of the handle 108 is above the vertical handle 110 and the longitudinal axis of handle 108 is perpendicular to the longitudinal axis of the long leg 124, as shown (embodying herein wherein said foot pedestal portion means comprises at least one substantially horizontal plate). Upon reading the teachings of this specification, those skilled in the art will now appreciate that, under appropriate circumstances, considering issues such as cost, ease of manufacturing, mechanical properties of the handle, etc., other handle configurations, such as curved, bent, angled, multiple portions, non-perpendicular, etc., may suffice.

Preferably, the narrow-trenching system tool 100 further comprises a vertical handle 110, as shown. Preferably, vertical handle 110 comprises a rod (embodying herein wherein such at least one handle comprises at least one rod), preferably a substantially hollow rod, preferably steel (embodying herein wherein such at least one rod comprises at least one substantially hollow steel rod), preferably tempered steel. Most preferably, vertical handle 110 comprises the same pipe as used for handle 108, a one-inch outer diameter steel pipe having a wall thickness of one-eighth of an inch. Upon reading the teachings of this specification, those skilled in the art will now appreciate that, under appropriate circumstances, considering issues such as weight, ease of manufacturing, mechanical properties of the configuration, cost, etc., other vertical handle configurations, such as differing thickness, non-hollow, non-steel, etc., may suffice.

Furthermore, vertical handle 110 preferably has a bend 122 (embodying herein wherein at least one handle comprises at least one bend), preferably located about twelve to sixteen inches above the bottom 120 of the vertical handle 110 (embodying herein such at least one bend is located about twelve-inches to about sixteen-inches above the bottom of such at least one handle bottom portion), as shown, depending on the overall length of the vertical handle and the desired bend to accommodate the user (embodying herein wherein said user-graspable element means is located at a horizontal distance from a vertical axis passing through said single blade means, structured and arranged to permit the user to apply maximum weight on said foot pedestal portion means while grasping said user-graspable element means). Preferably, the bend 120 provides that the long leg 124 of the vertical handle 110 is about two-degrees to about ten-degrees offset from the short leg 126 (embodying herein wherein such at least one bend is about two-degrees to about ten-degrees from vertical). Preferably, the bend 120 is on the opposite side and above the top portion 114 of the foot-plates 104 and 106, as shown (embodying herein wherein such at least one bend is opposite and above a top portion of such at least one foot pedestal).

Functionally, the bend 120 provides a means for a user to grasp the handle 108 (embodying herein wherein said handle top portion of said handle means comprises user-graspable element means) away from the body such that a more vertical position bearing weight onto the top portion 114 of the foot-plates 104 and 106 is achieved (as best illustrated in FIG. 6).

Furthermore, the bend or arcing of the vertical handle provides a vertical handle, which preferably allows a user with a larger belly to more comfortably use the tool. Preferably, the bottom four inches of the short leg 126 comprises a slot 128 through the center diameter of the handle 110, such that the blade 102 will fit snugly into the slot 128 to a depth of about four inches as illustrated by dimension A on FIG. 2. Under appropriate circumstances, other depth arrangements may suffice (should a manufacturer prefer to have a longer slot for increased stability or attachment). Preferably, the preferred depth will provide for a measured stop on the blade 102 such that the blade 102 may be sunk to a measured depth of about eight inches, the preferred trench depth of the narrow-trenching system as illustrated by Dimension B on FIG. 2. Most preferably, the vertical handle 110 is weldably attached to blade 102 (embodying herein wherein said handle means comprises attacher means for attaching said at least one handle bottom portion to said at least one handle top portion).

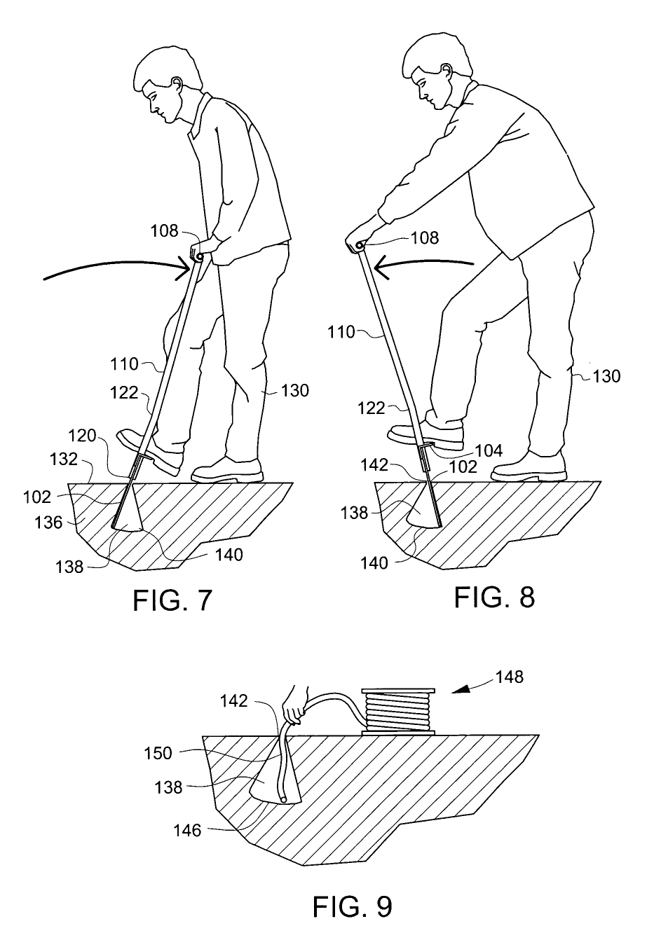

The following Figures illustrate a preferred method of using the narrow-trenching system tool 100. FIG. 6 is a perspective view, partially in section, of a first step in the method of use of the narrow-trenching system tool 100, according to a preferred embodiment of the present invention. FIG. 7 is a perspective view, partially in section, of a second step in the method of use of the narrow-trenching system tool 100, according to a preferred embodiment of the present invention. FIG. 8 is a perspective view, partially in section, of a third step in the method of use of the narrow-trenching system tool 100, according to a preferred embodiment of the present invention.

Preferably, the first step in the preferred method of using the narrow-trenching system tool 100 is soil penetration. Preferably, a user 130 positions the narrow-trenching system tool 100 such that the bend 120 is opposite the user 130, as shown. Preferably, the top portion 114 of the foot-plates 104 and 106 face the user, as shown. Preferably, user 130 has laid out a line in the soil, which the user desires to trench. Preferably, the user 130 positions the blade 102 vertically against the ground surface 132. Preferably, the user 130 places either foot 134 (right or left respectively on either the right or left facing foot-plate) onto the respective foot-plate 104 (as illustrated in FIG. 6), as shown. Preferably, the user 130 then grasps handle 108 and steps forward applying pressure on the foot-plate 104 or 106 (if using one foot) or both foot-plates 104 and 106 (if using two feet). Preferably, blade will cut through the surface and into the topsoil 136, as shown (embodying herein wherein applying downward force on said foot pedestal portion means, by the user, will normally assist said single blade means to cut through and penetrate the topsoil). Preferably, the blade 102 is forced into the topsoil to a depth of about eight inches. Most preferably, the eight inches is where the vertical handle 110 is attached to the blade 102, as shown (see FIG. 7 and FIG. 2). Upon reading the teachings of this specification, those with ordinary skill in the art, will now understand that, under appropriate circumstances, considering issues such as soil conditions, manufacturing preferences, etc., other depth arrangements, may suffice.

The next step in the preferred method of using the narrow-trenching system tool 100 is preferably the creation of a trench 138 below the surface 132. Preferably, the user 130 may form a trench 138 (or underground hollow) in the following manner. Grasping the handle 108 firmly and pulling the handle 108 such that the vertical handle 110 moves inward toward the user's body thereby sweeping the blade 102 in the opposite direction away from the user 130, as shown in FIG. 7. Preferably, the handle 108 is then pushed away from the user's body such that the vertical handle 110 moves away from the user's body and the blade 102 moves towards the user 130, as illustrated in FIG. 8 (embodying herein wherein applying a bi-directional horizontal force by the user to said user-graspable element means after penetration of the topsoil, while applying such downward force, will normally assist said single blade means to sweep an arc below the topsoil creating the trench with a wider bottom and a smaller top opening below the topsoil). It is noted that it is most preferable for the user 130 to have at least one foot applying weight to at least one of the foot-plates 104 or 106 to create a fulcrum in which the blade sweeps in an arc as intended and resists opening up the surface 132. In such manner, a trench 138 is created having an arced bottom 140 and a very narrow opening 142 at the surface 132, as shown.

FIG. 9 is a perspective view, partially in section, of a fourth step in the method of use of the narrow-trenching system tool 100, according to a preferred embodiment of the present invention. Preferably, the narrow-trenching system tool 100 is removed from the soil preferably leaving a trench 138 comprising a narrow opening 144 at the surface 132 and a larger underground hollow at the base 146, as shown.

Preferably, the narrow-trenching system tool 100 is moved adjacent the trench and the above steps are repeated such that a one-foot portion of trench 138 is created for each penetration and back and forth movement as described above (embodying herein creating the trench with a wider bottom and a smaller top opening below the topsoil). Preferably, when the trench 138 is the preferred length, the user removes the tool 100 (embodying herein removing the single blade means from the trench) and proceeds to entrench the desired material 148, such as the cable 150 illustrated in FIG. 9 (embodying herein placing the at least one trench element within the trench). For example, the cable 150 may be placed into the trench, as shown, by pushing the cable through the narrow opening 144 and into the base 146. When the desired material 148 has been entrenched, the user simply presses against the surface 132, preferably with a compaction tool, preferably the user's foot, such that the narrow opening is substantially closed and the surface vegetation is minimally disturbed (embodying herein closing the smaller top opening in the topsoil). Upon reading the teachings of this specification, those with ordinary skill in the art, will now understand that, under appropriate circumstances, considering issues such as user preferences, economic considerations, soil conditions, trench depth preferences, etc., other methods of using the narrow trenching system tool 100, may suffice.

Although applicant has described applicant's preferred embodiments of this invention, it will be understood that the broadest scope of this invention includes such modifications as diverse shapes and sizes and materials. Such scope is limited only by the below claims as read in connection with the above specification. Further, many other advantages of applicant's invention will be apparent to those skilled in the art from the above descriptions and the below claims.

What is claimed is:

1) A narrow-trenching tool system for transferring the force of a user to narrowly penetrate topsoil, create a trench with a wider bottom, and create a smaller top opening below the topsoil, comprising, in combination:
a) single blade means for cutting through the topsoil, having at least one blade top portion and at least one substantially horizontal bottom edge;
b) foot pedestal portion means for permitting the user to apply weight on said single blade means, situate adjacent to said at least one blade top portion; and
c) handle means for providing at least one handle, having at least one handle top portion and at least one handle bottom portion;
d) wherein said handle means comprises attacher means for attaching said at least one handle bottom portion to said at least one handle top portion;
e) wherein said handle top portion of said handle means comprises user-graspable element means;
f) wherein said user-graspable element means is located at a horizontal distance from a vertical axis passing through said single blade means, structured and arranged to permit the user to apply maximum weight on said foot pedestal portion means while grasping said user-graspable element means;
g) wherein applying downward force on said foot pedestal portion means, by the user, will normally assist said single blade means to cut through and penetrate the topsoil; and
h) wherein applying a bi-directional horizontal force by the user to said user-graspable element means after penetration of the topsoil, while applying such downward force, will normally assist said single blade means to sweep an arc below the topsoil creating the trench with a wider bottom and a smaller top opening below the topsoil.

2) The narrow-trenching tool system according to claim 1 wherein said user-graspable element means comprises at least one crossbar handle substantially perpendicular to said at least one handle top portion of said handle means.

3) The narrow-trenching tool system according to claim 2 wherein said foot pedestal portion means comprises at least one substantially horizontal plate.

4) A narrow-trenching tool system for transferring the force of a user to narrowly penetrate topsoil, create a trench with a wider bottom, and create a smaller top opening below the topsoil, comprising, in combination:
a) a single blade, having at least one blade top portion and at least one substantially horizontal bottom edge, structured and arranged to cut through the topsoil;
b) at least one foot pedestal portion, situate adjacent to said at least one blade top portion, structured and arranged to permit the user to apply weight on said single blade; and
c) at least one handle, having at least one handle top portion and at least one handle bottom portion;
d) wherein said at least one handle comprises at least one attacher structured and arranged to attach said at least one handle bottom portion to said at least one handle top portion;
e) wherein said at least one handle top portion of said at least one handle comprises at least one user-graspable element;
f) wherein said at least one user-graspable element is located at a horizontal distance from a vertical axis passing through said single blade, structured and arranged to permit the user to apply maximum weight on said at least one foot pedestal while grasping said at least one user-graspable element;
g) wherein applying downward force on said at least one foot pedestal portion by the user will normally assist said single blade to cut through and penetrate the topsoil; and
h) wherein applying a bi-directional horizontal force by the user to said at least one user-graspable element after penetration of the topsoil while applying such downward force will normally assist said single blade to sweep an arc below the topsoil creating the trench with a wider bottom and a smaller top opening below the topsoil.

5) The narrow-trenching tool system according to claim 4 wherein said at least one user-graspable element comprises at least one crossbar handle substantially perpendicular to said at least one handle top portion of said at least one handle.

6) The narrow-trenching tool system according to claim 5 wherein said at least one foot pedestal portion comprises at least one substantially horizontal plate.

7) The narrow-trenching tool system according to claim 4 wherein said single blade comprises a unitary metal blade.

8) The narrow-trenching tool system according to claim 7 wherein said unitary metal blade is tempered steel.

9) The narrow-trenching tool system according to claim 7 wherein said unitary metal blade is structured and arranged to penetrate the topsoil to a depth of between about six-inches and about twelve-inches.

10) The narrow-trenching tool system according to claim 7 wherein said unitary metal blade is structured and arranged to penetrate the topsoil to a depth of about eight-inches.

11) The narrow-trenching tool system according to claim 7 wherein said unitary metal blade is between about one-sixteenth-inch and about one-half inch thick.

12) The narrow-trenching tool system according to claim 4 wherein said at least one handle comprises at least one rod.

13) The narrow-trenching tool system according to claim 11 wherein said at least one rod comprises at least one substantially hollow steel rod.

14) The narrow-trenching tool system according to claim 12 wherein said at least one substantially hollow steel rod comprises an outer diameter of between about three-quarters of an inch and one-and-one-half inches.

15) The narrow-trenching tool system according to claim 5 wherein said at least one crossbar handle comprises at least one rod.

16) The narrow-trenching tool system according to claim 14 wherein said at least one rod comprises at least one substantially hollow steel rod.

17) The narrow-trenching tool system according to claim 5 wherein said at least one crossbar handle is weldably attached substantially perpendicular to said at least one handle top portion of said at least one handle.

18) The narrow-trenching tool system according to claim 4 wherein at least one handle comprises at least one bend.

19) The narrow-trenching tool system according to claim 17 wherein:
a) said at least one bend is located about twelve-inches to about sixteen-inches above the bottom of said at least one handle bottom portion; and
b) said at least one bend is about two-degrees to about ten-degrees from vertical.

20) The narrow-trenching tool system according to claim 18 wherein said at least one bend is opposite and above a top portion of said at least one foot pedestal.

21) A narrow-trenching tool system for transferring the force of a user to narrowly penetrate topsoil, create a trench with a wider bottom, and create a smaller top opening below the topsoil, comprising, in combination:
a) a single unitary tempered steel blade, having at least one blade top portion and at least one substantially horizontal bottom edge, structured and arranged to penetrate through the topsoil;
b) at least one foot pedestal portion, situate adjacent to said at least one blade top portion, structured and arranged to permit the user to apply weight on said single blade;
c) at least one handle, having at least one handle top portion and at least one handle bottom portion; and
d) at least one crossbar handle substantially perpendicular to said at least one handle top portion of said at least one handle;
e) wherein said at least one handle comprises at least one attacher structured and arranged to attach said at least one handle bottom portion to said at least one handle top portion;
f) wherein said at least one handle top portion of said at least one handle comprises at least one user-graspable element;
g) wherein said at least one crossbar handle is located at a horizontal distance from a vertical axis passing through said single blade, structured and arranged to permit the user to apply maximum weight on said at least one foot pedestal while grasping said at least one crossbar handle;
h) wherein said at least one handle comprises at least one bend located about twelve-inches to about sixteen-inches above the bottom of said at least one handle bottom portion;
i) wherein said at least one bend is about two-degrees to about ten-degrees from the vertical axis passing through said single blade;
j) wherein applying downward force on said at least one foot pedestal portion by the user will normally assist said single blade to cut through and penetrate the topsoil; and
k) wherein applying a bi-directional horizontal force by the user to said at least one user-graspable element after penetration of the topsoil while applying such downward force will normally assist said single blade to sweep an arc below the topsoil creating the trench with a wider bottom and a smaller top opening below the topsoil.

22) A narrow-trenching system method for narrowly penetrating topsoil, creating a trench with a wider bottom, and creating a smaller top opening below the topsoil, utilizing a narrow-trenching tool with single blade means for cutting through the topsoil, having at least one blade top portion and at least one substantially horizontal bottom edge; foot pedestal portion means for permitting the user to apply weight on such single blade means, situate adjacent to such at least one blade top portion; and handle means for providing a handle, having at least one handle top portion and at least one handle bottom portion; wherein such handle means comprises attacher means for attaching such at least one handle bottom portion to such at least one handle top portion; wherein such handle top portion of such handle means comprises user-graspable element means; wherein such user-graspable element means is located at a horizontal distance from a vertical axis passing through such single blade means, structured and arranged to permit the user to apply maximum weight on such foot pedestal portion means while grasping such user-graspable element means; wherein applying downward force on such foot pedestal portion means, by the user, will normally assist such single blade means to cut through and penetrate the topsoil; and wherein applying a bi-directional horizontal force by the user to such user-graspable element means after penetration of the topsoil, while applying such downward force, will normally assist such single blade means to sweep an arc below the topsoil creating the trench with a wider bottom and a smaller top opening below the topsoil, for placing of at least one trench element in such trench, comprising, in combination, the steps of:
a) positioning the at least one substantially horizontal bottom edge of the single blade means perpendicular to the topsoil;
b) applying pressure to the foot pedestal portion means;
c) wherein the single blade means penetrates the topsoil; and
d) applying a bi-directional horizontal force to the handle means.

23) The narrow-trenching system method according to claim 22 further comprising the steps of:
a) creating the trench with a wider bottom and a smaller top opening below the topsoil;
b) removing the single blade means from the trench;
c) placing the at least one trench element within the trench; and
d) closing the smaller top opening in the topsoil.
